(19) United States
(12) Patent Application Publication
(10) Pub. No.: US 2006/0141210 A1
(43) Pub. Date: Jun. 29, 2006

(54) Fixing structure of rod and synthetic resin component

(76) Inventors: Shigeo Nakamura, Aichi (JP); Junji Adachi, Aichi (JP)

Correspondence Address: FLYNN THIEL BOUTELL & TANIS, P.C., 2026 RAMBLING ROAD, KALAMAZOO, MI, 49008-1631, US

(21) Appl. No.: 10/532,637

(22) PCT Filed: Oct. 24, 2002
(86) PCT No.: PCT/JP02/11025

§ 371 Date: Dec. 19, 2005

(51) Int. Cl. B32B 3/10

(52) U.S. Cl. 428/137

(57) ABSTRACT

A fixing structure of a rod and a synthetic resin component in which an inserting part (6) of a rod (2) having widened rear side is formed in a synthetic resin component (3) and a stopper (7) projecting obliquely rearward from the inner surface of the inserting part (6) is provided in the rear side thereof in order to solve the problem of a prior art that the rod is not integral with the synthetic resin component fixed to the forward end of the rod. On the other hand, a recess (8) for stopping the forward end of the stopper (7) is formed in the side face at the forward end of the rod (2) and a part (10) for regulating the forward end position of the rod (2) is provided in the rear of the inserting part (6). The position regulating part (10) prevents or extremely minimizes upward fine movement of the synthetic resin component (3) with respect to the rod (2) and the stopper (7) prevents downward fine movement of the synthetic resin component (3) with respect to the rod (2).

### TECHNICAL FIELD

The present invention relates to a fixing structure in which a synthetic resin component is fixed to a forward end of a rod.

### BACKGROUND ART

Conventionally, as a typical example of a fixing structure in which a synthetic resin component is fixed to a forward end of a rod, there is known an opening and closing element support that supports an opening and closing element such as an engine hood of a motor vehicle in an opening state. As the opening and closing element support, Japanese Utility Model Examined Application Publication No. 8-2045 describes “an opening and closing element support that consists of a support rod and a support member attached to a forward end of the support rod and made of plastic, wherein the support rod includes a protruding engagement part in a direction around a shaft of the support rod, the support member includes a strike abutting on a peripheral surface of a hole edge of an engagement hole provided in the opening and closing element, an insertion part provided to protrude integrally on this strike and inserted into the engagement hole, and a fixing cylindrical part provided downward of and integrally with the strike and the support rod is attached thereto, an engagement protrusion engaged with the peripheral surface of the hole edge of the engagement hole of the opening and closing element is provided on a forward end of the insertion part while protruding downward of an undulating direction of the support, a stopper piece engaged with the engagement part of the support rod inserted into this fixing cylindrical part is provided to protrude inside the fixing cylindrical part, and rotation preventing means that prevents the support rod and the attachment cylindrical part from rotating together is provided at the support rod and the fixing cylindrical part”.

The support member of this opening and closing element support is promptly assembled into the support by inserting the support rod, and this insertion assembly enables maintaining a direction of the assembly without change.

However, the opening and closing element support has problems to be solved. For example, even if the assembly direction of the support member (synthetic resin component) relative to the support rod (rod) can be maintained, the support member makes a fine movement in a vertical direction. This disadvantageously makes integration of the support member (synthetic resin component) with the support rod (rod) poor.

### DISCLOSURE OF THE INVENTION

In view of the prior art problem that the support rod (rod) and the support member (synthetic resin component) are not integrated with each other, the present invention solves the problems by widening a rear side of a rod insertion part of the synthetic resin component, providing a stopper piece that protrudes obliquely rearward of an inner surface of the rear side of the insertion part of the synthetic resin component within the rear side thereof, forming a stopper recess on a forward end of the stopper piece on a side surface of a forward end of the rod, and providing a position regulating part that regulates a position of the forward end of the rod in a rear part of the insertion part to be abutted on or proximate to the forwarded end of the rod. By so constituting, the position regulating part prevents or extremely minimizes an upward fine movement of the synthetic resin component relative to the rod, and the stopper piece prevents a downward fine movement of the synthetic resin component relative to the stopper piece.

### BRIEF DESCRIPTION OF THE DRAWINGS

FIG. 1 is an enlarged view that depicts important parts of an opening and closing element support; FIG. 2 is an enlarged cross-sectional view taken along X-X shown in FIG. 1; FIG. 3 is an enlarged view that depicts important parts of an opening and closing element support according to another embodiment; and FIG. 4 is an enlarged cross-sectional view taken along Y-Y shown in FIG. 3.

### BEST MODE FOR CARRYING OUT THE INVENTION

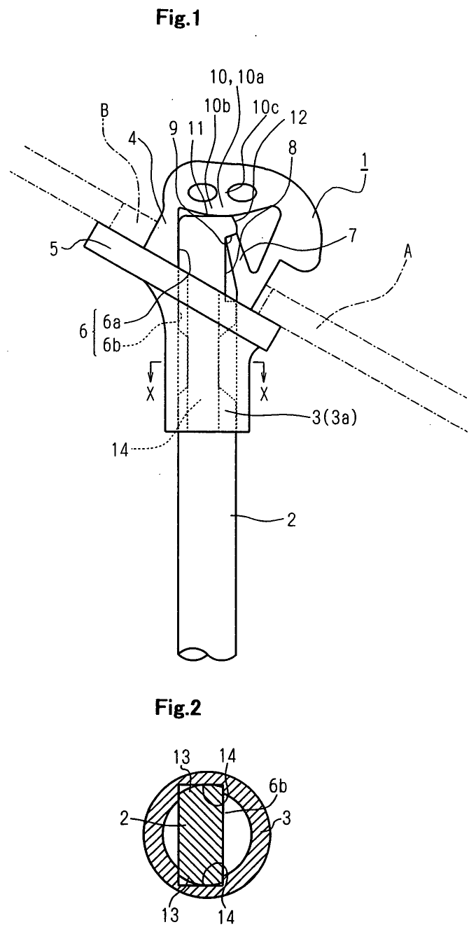

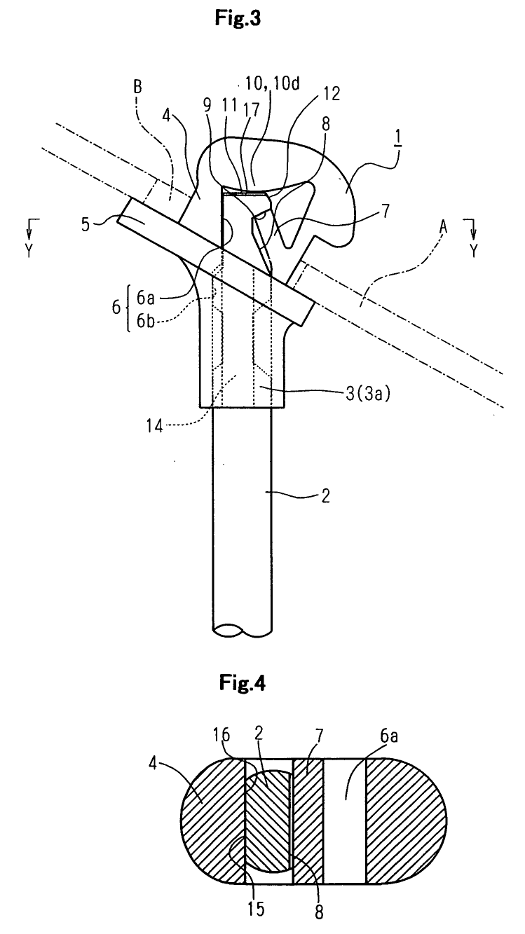

Embodiments of the present invention will be described hereinafter with reference to the drawings. In respect of a fixing structure of a rod and a synthetic resin component according to the present invention, FIG. 1 is an enlarged view that depicts important parts of an opening and closing element support, and FIG. 2 is an enlarged cross-sectional view taken along X-X shown in FIG. 1.

Referring to FIG. 1, similarly to the prior art, an opening and closing element support 1 is configured by a rod 2 which has a lower end rotatably attached to a vehicle body and which is allowed to freely undulate, and a support member 3a which is a synthetic resin component 3 attached to a forward end of the rod 2. An upper region of the support member 3a serves as an insertion part 4 inserted into an engagement hole B of an opening and closing element A, and a collar-like strike 5 is provided in a lower portion of the insertion part 4.

Further, the strike 5 is formed to be larger than the engagement hole B so as to receive a peripheral portion of the engagement hole B of the opening and closing element A.

A rear side of the insertion part 6 of a rod 2, which is formed in the support member 3a, is formed wide to provide a containing region 6a in which a forward end of the rod 2 is contained, and an inlet side of the insertion part 6 is formed as a fitting and inserting region 6b into which the rod 2 is fitted and inserted. By opening the containing region 6a on both sides of the insertion part 4, the insertion part 4 is formed into a frame.

A stopper piece 7 protruding obliquely to the rear side of the insertion part 6 is provided within the containing region 6a of the support member 3a, and formed integrally with the support member 3a. On the other hand, a stopper recess 8 of a forward end of the stopper piece 7 is formed on a side surface of the forward end of the rod 2. In addition, an abutment surface 9 of the forward end of the stopper piece 7 directed toward a proximal end of the rod 2 is formed on the stopper recess 8.

A pressing member 10a, which serves as a position regulating part 10 that regulates a position of the forward end of the rod 2, is provided in a rear part of the containing region 6a, and formed integrally with the support member 3a. On the other hand, an abutment surface 11 of the pressing member 10a directed toward the rear side of the containing region 6a is formed on the forward end side of the rod 2. The abutment surface 11 also serves as a forward end surface of the rod 2 according to this embodiment.

As shown in FIG. 1, the pressing member 10a according to this embodiment is a compression elastic member formed integrally with a central part of a plate member 10b of a downward circular arc shape and a rear part of a insertion part 6, via a coupling member 10c. However, the pressing member 10a according to the present invention is not limited to this. The pressing member 10a may be, for example, a folded plate-like compression elastic member, not shown, provided in the rear part of the containing region 6a, may be a compression elastic member, e.g., a compression spring, provided separately from the support member 3a, or may be a simple protrusion protruding integrally with the rear part of the insertion part 6. In addition, the abutment surface 11 of the pressing member 10a may be a surface directed toward the rear side of the insertion part 6 in a stepped part provided on the forward end side of the rod 2.

As shown in FIG. 2, a protrusion 13 may be formed in a side of a portion within the fitting and inserting region 6b of the insertion part 6 of the rod 2, and a fitting groove 1 of the protrusion 13 may be formed in an inner peripheral surface of the fitting and inserting region 6b of the insertion part 6. As shown in FIGS. 1 and 2, an intermediate part of the rod 2 is compressed, whereby the protrusion 13 protrudes on both sides thereof.

As shown in FIG. 1, it is preferable to form the insertion part 6 on the support member 3a so that an opposite region to the stopper recess 8 in the insertion part 6 of the rod 2 is closely attached to an inner peripheral surface of the insertion part 6.

According to another embodiment shown in FIGS. 3 and 4, an opening and closing element support 1 is configured by a rod 2 similar to that of the opening and closing element support 1 shown in FIGS. 1 and 2, and a support member 3a which is a synthetic resin component 3 that includes an insertion part 4 and a strike 5. A stopper piece 7 is formed in a containing region 6a of the support member 3a, and a stopper recess 8 of a forward end of the stopper piece 7 is formed on a side surface of a forward end of the rod 2. An abutment surface 9 of the stopper recess 8 is formed as an inclined guide surface, and a position regulating part 10 in a rear part of the containing region 6a is formed not as a pressing member 10a but simply as a convex 10d having a convex curved surface. In addition, a flat surface 15 is formed on an opposite side to the stopper recess 8 on the side surface of the forward end of the rod 2, and a flat surface 16 in close contact with the flat surface 15 is formed in the insertion part 6 of the support member 3a. The flat surface 15 of the rod 2 is formed by compressing the forward end of the rod 2, and a part protruding on both sides of the rod 2 due to the compression is formed on an extension of the protrusion 13 as shown in FIG. 4. A chamfer 17 is formed on an edge of the forward end of the rod 2. The forward end surface of the rod 2 is made to be abutted on or proximate to the position regulating part 10 in the rear part of the containing region 6a, i.e., the convex 10d.

Although this embodiment has been described while taking the opening and closing element support 1 as an example, the present invention is not limited to such a product. The present invention is applicable to any product as long as the product is configured so that the forward end of the rod 2 is inserted into the insertion part 6 of the synthetic resin component 3 to thereby integrate the rod 2 with the synthetic resin component 3.

A process of attaching the synthetic resin component 3 to the forward end of the rod 2 will next be described in detail.

In the process of inserting the forward end of the rod 2 into the insertion part 6 of the synthetic resin component 3, an inclined slide surface 12 on the forward end of the rod 2 is first abutted on the stopper piece 7 to bring down the stopper piece 7. Next, the rod 2 moves forward with the forward end of the stopper piece 7 in slidable contact with an outer peripheral surface of the rod 2, and the abutment surface 11 on the forward end side of the rod 2, i.e., the forward end surface of the rod 2 is abutted on the pressing member 10a to deform the pressing member 10a. When the forward end of the stopper piece 7 is located in the stopper recess 8 and is deviated from the peripheral surface of the rod 2, the stopper piece 7 is returned to its initial position by an elastic restoring force and the forward end of the stopper piece 7 is fitted into the stopper recess 8. Finally, the rod 2 is pressed down by the elastic restoring force of the pressing member 10a, the forward end of the stopper piece 7 is abutted on the abutment surface 9 of the stopper recess 8, and the synthetic resin component 3 is fixedly attached to the forward end of the rod 2.

Furthermore, the inclined slide surface 12 on the forward end of the rod 2 is abutted on the stopper piece 7, whereby the stopper piece 7 is prevented from being scraped off during attachment of the synthetic resin component 3 to the forward end of the rod 2.

In the process of inserting the rod 2 into the insertion part 6 of the synthetic resin component 3, after the forward end of the rod 2 is abutted on the stopper piece 7, the stopper piece 7 is slightly deformed and a side of the synthetic resin component 3 is elastically deformed to expand outward, whereby the forward end of the stopper piece 7 slidably contacts with the outer peripheral surface of the rod 2. The forward end of the rod 2 is then abutted on the pressing member 10a in the rear side of the insertion part 6 to deform the pressing member 10a, the forward end of the synthetic resin component 3 is elastically deformed to expand outward, the synthetic resin component 3 which has been attached to the rod 2 remains deformed extremely slightly, and the elastic restoring force of the component 3 acts on the rod 2 via the stopper piece 7 and the pressing member 10a. As a result, the rod 2 and the synthetic resin component 3 are integrated with each other further strongly.

According to another embodiment shown in FIGS. 3 and 4, the chamfer 17 on the forward end of the rod 2 is first abutted on the stopper piece 7 to bring down the stopper piece 7. Next, the rod 2 moves forward with the forward end of the stopper piece 7 in slidable contact with an outer peripheral surface of the rod 2. When the forward end of the stopper piece 7 is located in the stopper recess 8 and deviated from the peripheral surface of the rod 2, the stopper piece 7 is returned to its initial position by an elastic restoring force and the rod 2 moves forward with the forward end of the stopper piece 7 in slidable contact with the abutment surface 9. Finally, the forward end of the stopper piece 7 is fitted into the stopper recess 8, the forwarded end of the rod 2 is abutted on or proximate to the position regulating part 10, i.e., the convex 10d, and the synthetic resin component 3 is fixedly attached to the forward end of the rod 2.

In the process of inserting the rod 2 into the insertion part 6 of the synthetic resin component 3, after the forward end of the rod 2 is abutted on the stopper piece 7, the stopper piece 7 is slightly deformed and a side of the synthetic resin component 3 is elastically deformed to expand outward, whereby the forward end of the stopper piece 7 slidably contacts with the outer peripheral surface of the rod 2. The synthetic resin component 3 which has been attached to the rod 2 remains deformed extremely slightly, and the elastic restoring force of the component 3 acts on the rod 2 via the stopper piece 7 and the flat surface 16. As a result, the rod 2 and the synthetic resin component 3 are integrated with each other further strongly.

A function of the fixing structure of fixing the synthetic resin component to the rod according to the present invention will next be described.

In the first embodiment, the rod 2 is brought down by the elastic restoring force of both of or one of the pressing member 10a and the forward end of the synthetic resin component 3. In the second embodiment, by making the forward end of the rod 2 abutted on or proximate to the convex 10d, the upward fine movement of the synthetic resin component 3 relative to the rod 2 is prevented or extremely minimized. In addition, the forward end of the stopper piece 7 is engaged with the stopper recess 8 of the rod 2 and abutted on the abutment surface 9. Due to this, the vertical fine movement of the synthetic resin component 3 relative to the rod 2 is completely prevented or extremely minimized.

The stopper piece 7 and the pressing member 10a according to the first embodiment and the stopper piece 7 according to the second embodiment are formed so as not to be easily deformed when a load is exerted on the synthetic resin component 3 from above, for example, when the opening and closing element support supports the opening and closing element A to be open. For this reason, these elements are required to have strengths to some degree. Considering this, the insertion part 4 is opened on the rear side of the insertion part 6, i.e., the containing region 6a is opened on the both sides of the insertion part 4 to be formed into a frame. It is thereby possible to facilitate deforming the insertion part 4 and fix the synthetic resin component 3 to the rod 2 without greatly deforming the stopper piece 7 and the pressing member 10a according to the first embodiment or the stopper piece 7 according to the second embodiment.

### INDUSTRIAL APPLICABILITY

In short, according to the present invention, the rear side of the insertion part 6 of the synthetic resin component 3 into which the rod 2 is inserted is widened, the stopper piece 7 that protrudes obliquely rearward of the inner surface of the rear side of the insertion part 6 is provided within the rear side thereof, and the stopper recess 8 on a forward end of the stopper piece 7 is formed on the side surface of the forward end of the rod 2. Therefore, the engagement structure in which the forward end of the stopper piece 7 is engaged with the stopper recess 8 can prevent the synthetic resin component 3 from detaching from the rod 2.

Further, the position regulating part 10 that regulates the position of the forward end of the rod 2 is provided in the rear part of the insertion part 6. Accordingly, the position regulating part 10 makes a positioning of the forward end of the rod 2. It is, therefore, possible to prevent or extremely minimize the vertical fine movement of the synthetic resin component 3 in the fixed state.

Besides, the pressing member 10a is abutted on the forward end of the rod 2, and the forward end of the stopper piece 7 is abutted on the upper part of the stopper recess 8. It is, therefore, possible to maintain the assembly direction of the synthetic resin component 3 relative to the rod 2.

Hence, the present invention can provide the product excellent in the integration of the rod 2 with the synthetic resin component 3.

The position regulating part 10 is provided as the pressing member 10a that is the compression elastic body formed integrally with the synthetic resin component 3. The pressing member 10a is elastically deformable, so that the forward end of the rod 2 can be inserted further rearward of the abutment position at which the rod 2 is abutted on the pressing member 10a. It is, therefore, possible to engage the forward end of the stopper piece 7 with the stopper recess 8 without greatly deforming the synthetic resin component 3. In addition, a closeness between the pressing member 10a and the forward end of the rod 2 and that between the stopper piece 7 and the abutment region of the stopper recess 8 are further enhanced by the elastic restoring force of the pressing member 10a. It is, therefore, possible to further improve the integration of the synthetic resin component 3 with the rod 2.

The insertion part 4 is formed into a frame by opening the rear side of the insertion part 6 on both sides of the insertion part 4. It is, therefore, possible to form the insertion part 4 to be easily deformable. This can thereby facilitate a work of attaching the synthetic resin component 3 to the rod 2.

The protrusion 13 is provided on the side surface of the forward end of the rod 2, and the fitting groove 14 into which the protrusion 13 is fitted is provided in the inner side surface of the inlet-side region of the insertion part 6 of the synthetic resin component 3. Alternatively, the flat surface 15 is formed on the opposite side to the stopper recess 8 on the side surface of the forward end of the rod 2, and the flat surface 16 closely contacting with the flat surface 15 is formed on the insertion part 6 of the synthetic resin component 3. It is, therefore, possible to prevent the rotation and fine movement of the synthetic resin component 3 relative to the rod 2. This can further enhance the integration of the synthetic resin component 3 with the rod 2. Hence, the present invention exhibits greatly practical advantages.

1. A fixing structure of attaching a synthetic resin component to a forward end of a rod by inserting the forward end of the rod into an insertion part of the synthetic resin component, wherein a rear side of said insertion part is widened, a stopper piece that protrudes obliquely rearward of an inner surface of the rear side of the insertion part is provided within the rear side thereof, a stopper recess on a forward end of the stopper piece is formed on a side surface of the forward end of the rod, and a position regulating part, on which the forward end of the rod is abutted during insertion of the rod, is provided in a rear part of the insertion part.

2. The fixing structure of the rod and the synthetic resin component according to claim 1, wherein
the position regulating part is a pressing member that is a compression elastic body formed integrally with the synthetic resin component.

3. The fixing structure of the rod and the synthetic resin component according to claim 1, wherein
an upper region of the synthetic resin component is formed into a frame by opening the rear side of the insertion part on both sides of the upper region of the synthetic resin component.

4. The fixing structure of the rod and the synthetic resin component according to claim 1, wherein
a protrusion is provided on the side surface of the forward end of the rod, and a fitting groove into which the protrusion is fitted is provided in an inner side surface of an inlet-side region of the insertion part of the synthetic resin component.

5. The fixing structure of the rod and the synthetic resin component according to claim 1, wherein
a flat surface is formed on an opposite side to the stopper recess on the side surface of the forward end of the rod, and a flat surface closely contacting with said flat surface is formed on the insertion part of the synthetic resin component.
